(19) United States
(12) Patent Application Publication
(10) Pub. No.: US 2025/0153663 A1
(43) Pub. Date: May 15, 2025

(54) ROUTING STRUCTURE

(71) Applicant: YAZAKI CORPORATION, Tokyo (JP)

(72) Inventors: Kosuke Tomosada, Makinohara-shi (JP); Naoto Kogure, Makinohara-shi (JP)

(21) Appl. No.: 18/940,736

(22) Filed: Nov. 7, 2024

(30) Foreign Application Priority Data
Nov. 13, 2023 (JP) 2023-192669

(51) Int. Cl. B60R 16/02; B60J 7/043; H02G 11/00

(52) U.S. Cl. CPC B60R 16/0215; H02G 11/00; B60J 7/043

(57) ABSTRACT

A routing structure includes: a first fixing part fixed to a vehicle body of a vehicle; a second fixing part fixed to a slide body that moves along a vehicle front-rear direction with respect to an opening provided in a roof of the vehicle body; an exterior member having a first end portion held by the first fixing part and a second end portion held by the second fixing part; and a plurality of electric wires inserted through the exterior member. The first fixing part and the second fixing part hold the exterior member so as to form a curved portion in which the exterior member is curved in the vehicle front-rear direction between the first end portion and the second end portion, and the plurality of electric wires have a stranded wire portion extending inside the exterior member.

### CROSS-REFERENCE TO RELATED APPLICATION(S)

The present application claims priority to and incorporates by reference the entire contents of Japanese Patent Application No. 2023-192669 filed in Japan on Nov. 13, 2023.

### BACKGROUND OF THE INVENTION

### 1. Field of the Invention

The present invention relates to a routing structure.

### 2. Description of the Related Art

Conventionally, there is a power feeding device for a slide body. Japanese Patent Application Laid-open No. 2011-151906 discloses a power feeding device for a slide body including a wire harness routed over a vehicle body and a slide body that is slidably provided on the vehicle body and opens and closes an opening formed in the vehicle body.

Here, when an electric wire is curved in a narrow space between the vehicle body and the slide body, the durability of the electric wire against bending is easily affected. In the electric wire routed between the vehicle body and the slide body, it is desirable to suppress a decrease in durability against bending.

### SUMMARY OF THE INVENTION

An object of the present invention is to provide a routing structure capable of suppressing a decrease in durability of an electric wire against bending.

In order to achieve the above mentioned object, a routing structure according to one aspect of the present invention includes a first fixing part fixed to a vehicle body of a vehicle; a second fixing part fixed to a slide body that moves along a vehicle front-rear direction with respect to an opening provided in a roof of the vehicle body; an exterior member having a first end portion held by the first fixing part and a second end portion held by the second fixing part; and a plurality of electric wires inserted through the exterior member, wherein the first fixing part and the second fixing part hold the exterior member so as to form a curved portion in which the exterior member is curved in the vehicle front-rear direction between the first end portion and the second end portion, the plurality of electric wires have a stranded wire portion extending inside the exterior member, and the plurality of electric wires are twisted together in the stranded wire portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a routing structure according to an embodiment;

FIG. 2 is a side view of the routing structure according to the embodiment;

FIG. 3 is a cross-sectional view of the routing structure according to the embodiment;

FIG. 4 is a side view of the routing structure according to the embodiment;

FIG. 5 is a plan view illustrating electric wires arranged on a biasing member;

FIG. 6 is a view illustrating a stranded wire portion of a second shape;

FIG. 7 is a plan view illustrating electric wires arranged on the biasing member;

FIG. 8 is a view illustrating electric wires connected to a device on a power source side;

FIG. 9 is a view illustrating electric wires connected to a device on a slide body;

FIG. 10 is a view illustrating a stranded wire portion of a third shape;

FIG. 11 is a cross-sectional view of the routing structure according to the embodiment; and

FIG. 12 is a view illustrating a stranded wire portion of a fourth shape.

### DETAILED DESCRIPTION OF THE PREFERRED EMBODIMENTS

Hereinafter, a routing structure according to an embodiment of the present invention will be described in detail with reference to the drawings. Note that the present invention is not limited by the present embodiment. In addition, the components in the following embodiment include those that can be easily imagined by those skilled in the art or those that are substantially the same.

### EMBODIMENT

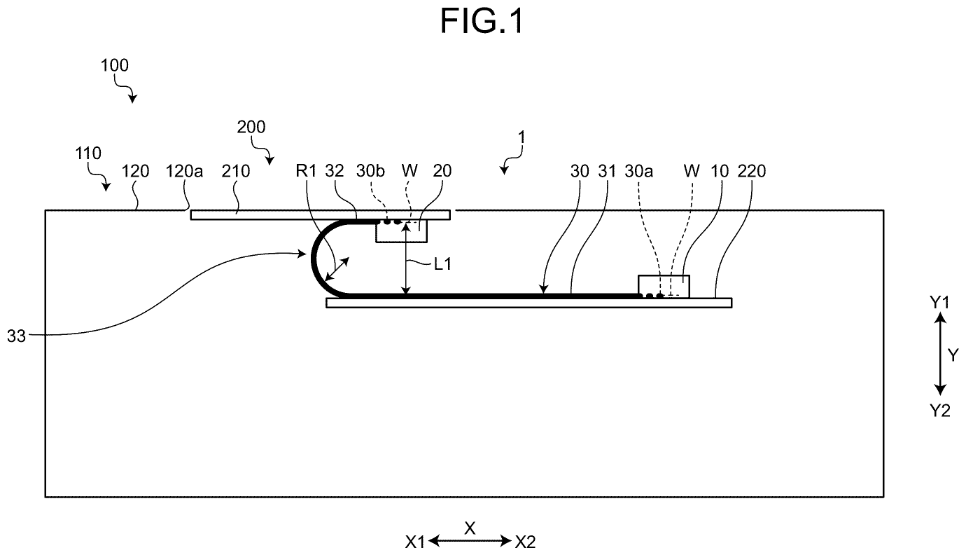

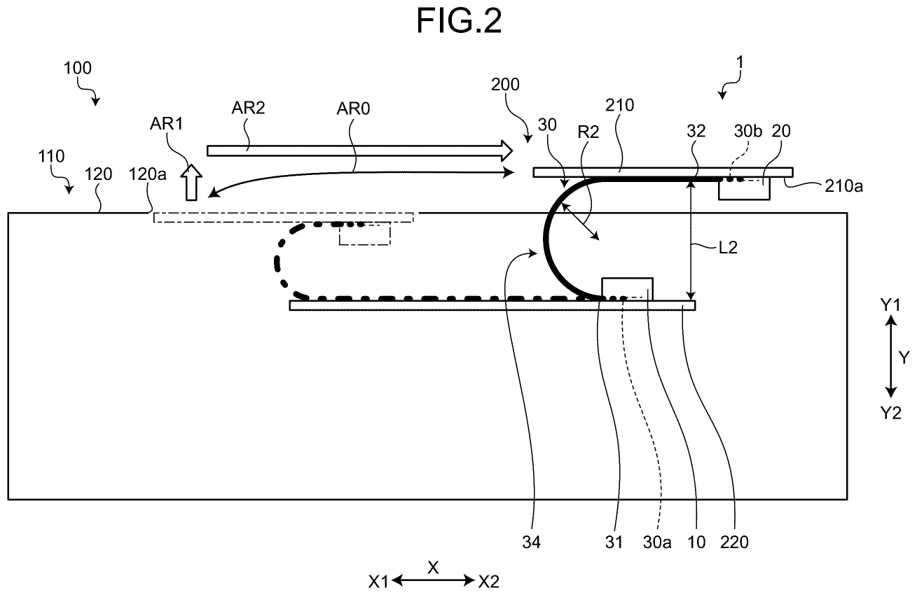

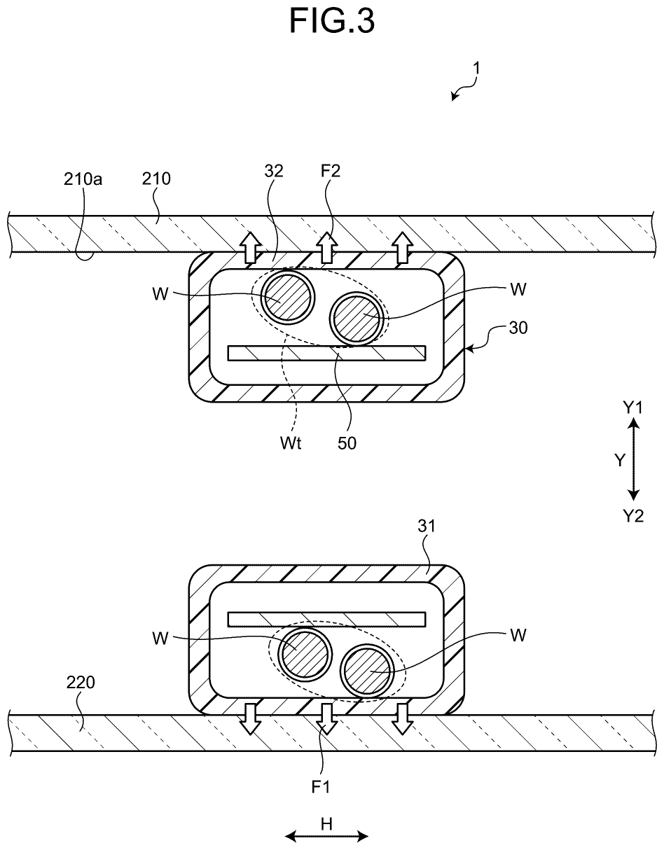

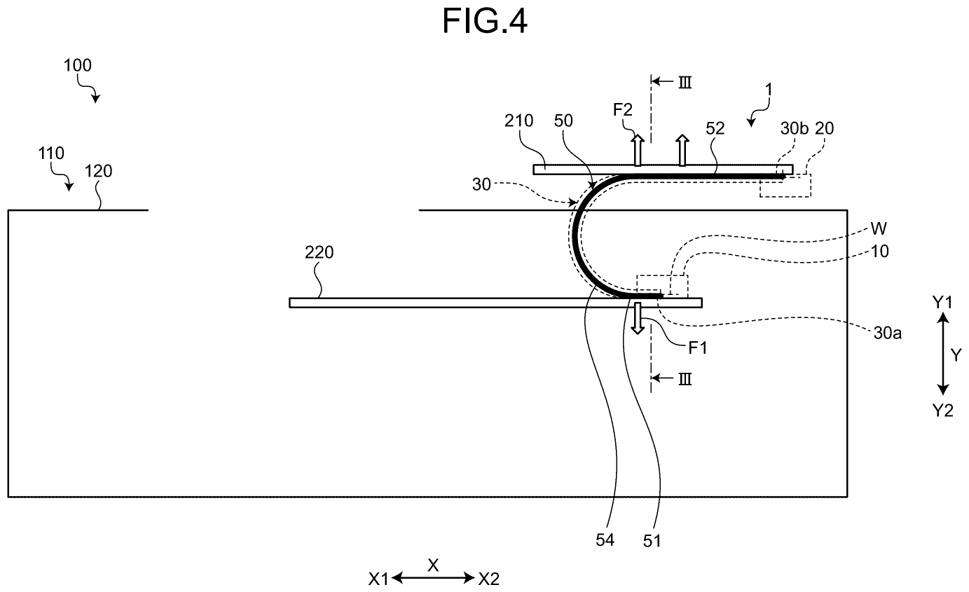

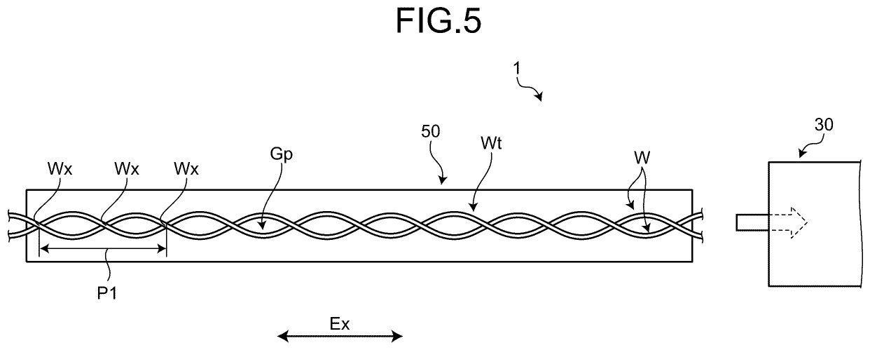

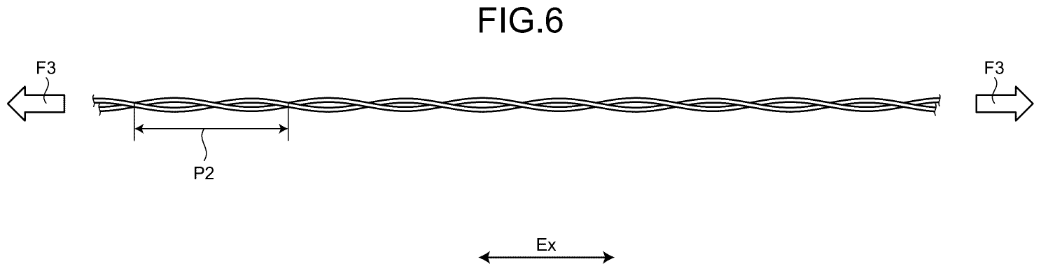

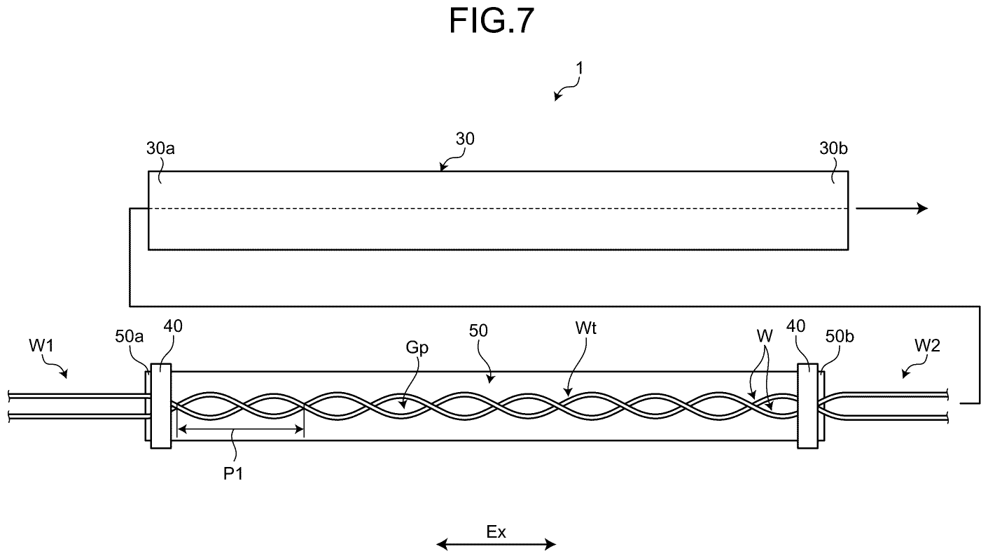

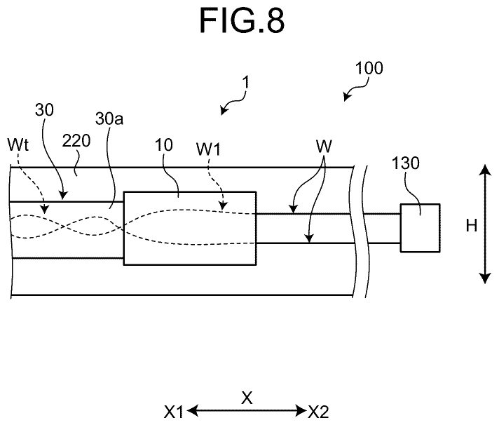

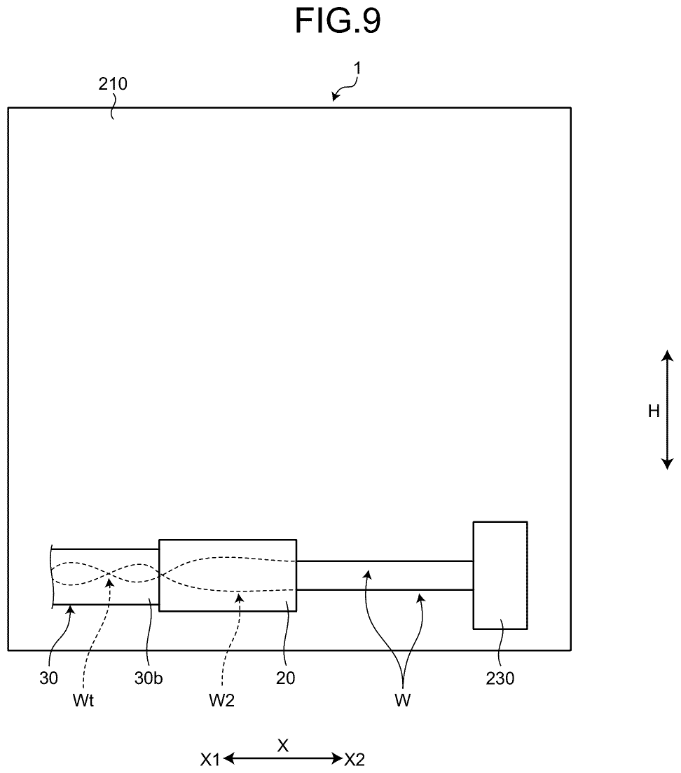

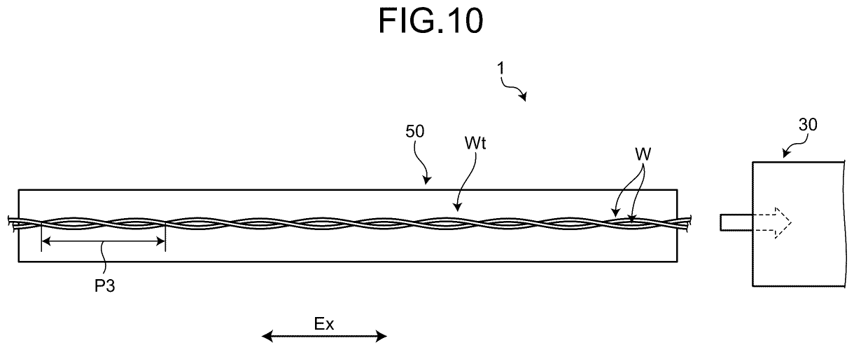

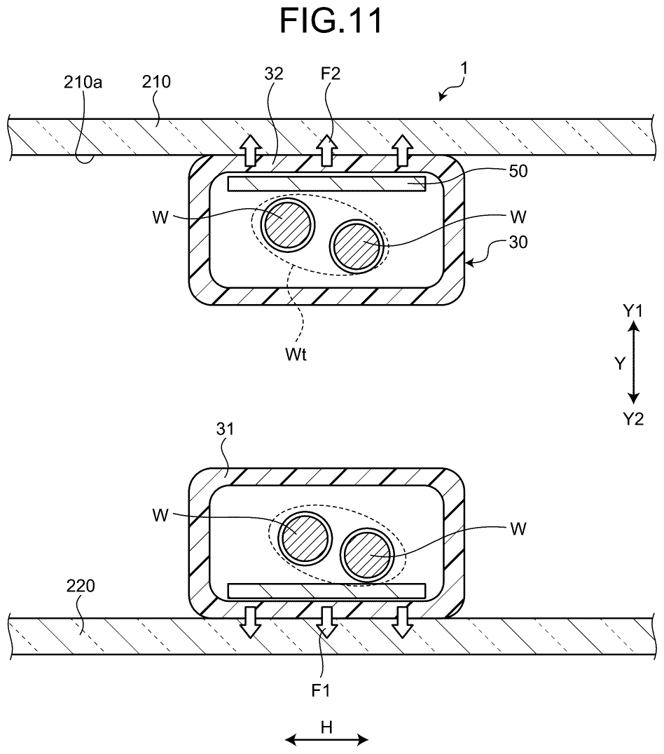

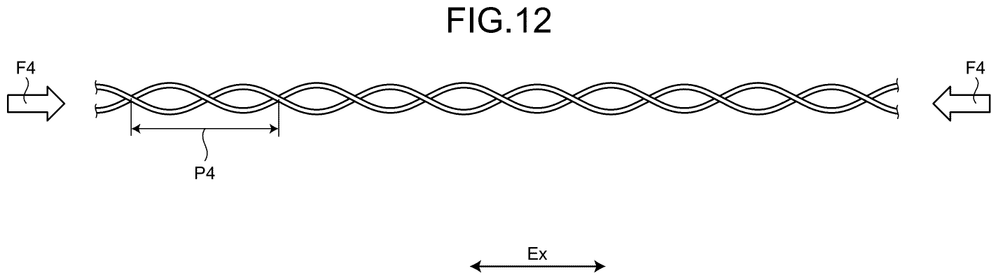

An embodiment will be described with reference to FIGS. 1 to 12. The present embodiment relates to a routing structure. FIGS. 1 and 2 are side views of the routing structure according to the embodiment, FIG. 3 is a cross-sectional view of the routing structure according to the embodiment, FIG. 4 is a side view of the routing structure according to the embodiment, FIG. 5 is a plan view illustrating electric wires arranged on a biasing member, FIG. 6 is a view illustrating a stranded wire portion of a second shape, FIG. 7 is a plan view illustrating electric wires arranged on the biasing member, FIG. 8 is a view illustrating electric wires connected to a device on a power source side, FIG. 9 is a view illustrating electric wires connected to a device on a slide body, FIG. 10 is a view illustrating a stranded wire portion of a third shape, FIG. 11 is a cross-sectional view of the routing structure according to the embodiment, and FIG. 12 is a view illustrating a stranded wire portion of a fourth shape. FIG. 3 illustrates a cross section taken along line III-III in FIG. 4.

As illustrated in FIG. 1, a routing structure 1 according to the embodiment is applied to a sunroof 200 of a vehicle 100. The vehicle 100 is, for example, an automobile on which a power source such as a motor or an engine is mounted. The vehicle 100 includes a vehicle body 110. The vehicle body 110 has a roof 120 that covers the vehicle interior. The roof 120 has an opening 120a that is open upward.

The vehicle 100 includes a sunroof 200 that opens and closes the opening 120a. The sunroof 200 has a slide body 210, a rail 220, and a routing structure 1. The slide body 210 is a member that slides along a vehicle front-rear direction X with respect to the opening 120a. The slide body 210 according to the present embodiment is a plate-like member that closes the opening 120a or opens the opening 120a. The slide body 210 may be glass configured to allow light to be transmitted therethrough.

The sunroof 200 includes a mechanism such as a link mechanism that moves the slide body 210 along a predetermined path, and a drive source such as a motor that operates the above mechanism. The sunroof 200 moves the slide body 210 between a fully closed position where the opening 120a is closed and a fully opened position where the opening 120a is opened. FIG. 1 illustrates the slide body 210 at the fully closed position. FIG. 2 illustrates the slide body 210 at the fully opened position.

The rail 220 is fixed to the vehicle body 110. The rail 220 extends in the vehicle front-rear direction X. The rail 220 supports the mechanism for moving the slide body 210, and guides the mechanism in the vehicle front-rear direction X. The rail 220 further supports an exterior member 30, and forms a first extending portion 31 in a straight shape on the exterior member 30.

The sunroof 200 according to the present embodiment moves the slide body 210 along a path AR0 illustrated in FIG. 2. The movement of the slide body 210 along the path AR0 includes a movement along the vehicle front-rear direction X and a movement along a vehicle up-down direction Y. When the slide body 210 moves from the fully closed position toward the fully opened position, the slide body 210 moves toward an upper side Y1 in the vehicle up-down direction Y and moves toward a rear side X2 in the vehicle front-rear direction X as indicated by an arrow AR1 in FIG. 2.

Conversely, when the slide body 210 moves from the fully opened position to the fully closed position, the slide body 210 moves toward a front side X1 in the vehicle front-rear direction X and moves toward a lower side Y2 in the vehicle up-down direction Y.

As illustrated in FIGS. 1 to 3, the routing structure 1 includes a first fixing part 10, a second fixing part 20, an exterior member 30, an electric wire W, and a biasing member 50. The exterior member 30 and the electric wire W constitute a wire harness routed between the vehicle body 110 and the slide body 210.

The first fixing part 10 is a member fixed to the vehicle body 110 of the vehicle 100. The first fixing part 10 according to the present embodiment is fixed to the rail 220. The first fixing part 10 may be a protector that protects the electric wire W. The first fixing part 10 is formed of, for example, an insulating synthetic resin. The first fixing part 10 has a space in which the electric wire W is routed and has a holding structure for holding the exterior member 30.

The second fixing part 20 is a member fixed to the slide body 210 of the sunroof 200. The second fixing part 20 may be a protector that protects the electric wire W. The second fixing part 20 is formed of, for example, an insulating synthetic resin. The second fixing part 20 has a space in which the electric wire W is routed and has a holding structure for holding the exterior member 30.

The exterior member 30 is an elastically deformable tubular member. The exterior member 30 is, for example, a member called a corrugated tube. The exterior member 30 is formed of, for example, an insulating synthetic resin. The exterior member 30 may have a bellows shape.

The exterior member 30 has a first end portion 30a held by the first fixing part 10 and a second end portion 30b held by the second fixing part 20. The first fixing part 10 holds the first end portion 30a such that the exterior member 30 extends from the first fixing part 10 along the rail 220 in the vehicle front-rear direction X. The first fixing part 10 according to the present embodiment holds the first end portion 30a such that the exterior member 30 extends from the first fixing part 10 toward the front side X1.

The second fixing part 20 holds the second end portion 30b such that the exterior member 30 extends from the second fixing part 20 along the slide body 210 in the vehicle front-rear direction X. The second fixing part 20 according to the present embodiment holds the second end portion 30b such that the exterior member 30 extends from the second fixing part 20 toward the front side X1.

The plurality of electric wires W and the biasing member 50 are inserted through the exterior member 30. The electric wire W is, for example, a sheathed electric wire having a stranded wire and a sheath. The electric wire W drawn out from the first end portion 30a is connected to a power supply and a control device disposed in the vehicle body 110. The electric wire W drawn out from the second end portion 30b is connected to a load disposed on the slide body 210. The load disposed on the slide body 210 may be, for example, a lighting device, a light control film disposed on the glass of the slide body 210, or another electric load.

As illustrated in FIGS. 1 and 2, the exterior member 30 has a curved portion 33 or 34 that is curved in the vehicle front-rear direction X between the first end portion 30a and the second end portion 30b. The curved portion 33 or 34 is formed by, for example, the biasing member 50. The curved portion 33 illustrated in FIG. 1 is a curved portion formed in the exterior member 30 in a state where the slide body 210 is at the fully closed position. The curved portion 33 has a radius R1. The curved portion 34 illustrated in FIG. 2 is a curved portion formed in the exterior member 30 in a state where the slide body 210 is at the fully opened position. The curved portion 34 has a radius R2. The electric wire W in which the curved portion 33 or 34 is formed has a U shape or a J shape.

As illustrated in FIG. 1, when the slide body 210 is at the fully closed position, a distance of the second end portion 30b from the first end portion 30a in the vehicle up-down direction Y is a first distance L1. The radius R1 of the curved portion 33 is half the first distance L1.

As illustrated in FIG. 2, when the slide body 210 is at the fully opened position, a distance of the second end portion 30b from the first end portion 30a in the vehicle up-down direction Y is a second distance L2. The radius R2 of the curved portion 34 is half the second distance L2.

In the sunroof 200 according to the present embodiment, the second distance L2 at the fully opened position is larger than the first distance L1 at the fully closed position. Accordingly, the radius R1 of the curved portion 33 when the slide body 210 is at the fully closed position is smaller than the radius R2 of the curved portion 34 when the slide body 210 is at the fully opened position. In addition, the radius R1 when the slide body 210 is at the fully closed position is smaller than a radius of a curved shape formed in the biasing member 50 when the slide body 210 is at another position. In other words, the curved shape formed in the biasing member 50 has a smallest radius when the slide body 210 is at the fully closed position.

The second end portion 30b of the exterior member 30 moves together with the slide body 210. At this time, the exterior member 30 follows the movement of the second fixing part 20 while gradually changing the position where the curved shape is formed.

The biasing member 50 according to the present embodiment is a member that presses the exterior member 30 toward the slide body 210. The biasing member 50 according to the present embodiment is a plate-like member, and is elastically deformable. The biasing member 50 is formed of a metal or a resin.

As illustrated in FIG. 3, the exterior member 30 according to the present embodiment has a rectangular cross-sectional shape. The exemplified shape of the biasing member 50 is a flat plate shape. In the biasing member 50, a cross-sectional shape orthogonal to an axial direction of the biasing member 50 is rectangular. The biasing member 50 extends from one end to the other end in a width direction H in the internal space of the exterior member 30. The biasing member 50 faces each of a plurality of electric wires W in the vehicle up-down direction Y. In other words, the biasing member 50 has a width capable of supporting the plurality of electric wires W.

The biasing member 50 in FIG. 3 is disposed inside the electric wire W. Therefore, in the curved portion 33 or 34, the biasing member 50 is positioned inside the electric wire W in a radial direction. As illustrated in FIG. 3, the biasing member 50 applies pressing forces F1 and F2 to the exterior member 30.

As illustrated in FIG. 4, the exterior member 30, the electric wire W, and the biasing member 50 are routed in a curved state in a U shape or a J shape. That is, the biasing member 50 extends from the first fixing part 10 to the second fixing part 20 with a curved portion 54.

The biasing member 50 bent to have the curved portion 54 applies the pressing force F1 and the pressing force F2 to the exterior member 30. The pressing force F1 is a force in the vehicle up-down direction Y, and presses the exterior member 30 toward the rail 220. The pressing force F2 is a force in the vehicle up-down direction Y, and presses the exterior member 30 toward the slide body 210. The pressing forces F1 and F2 are restoring forces generated in the bent biasing member 50.

The pressing force F1 forms a first extending portion 31 in the exterior member 30. The pressing force F2 forms a second extending portion 32 in the exterior member 30. As illustrated in FIG. 2, etc., the second extending portion 32 is a portion extending along a vehicle interior side surface 210a of the slide body 210. The vehicle interior side surface 210a is a surface facing the lower side Y2. When the vehicle interior side surface 210a is a flat surface, the second extending portion 32 is formed straight. When the vehicle interior side surface 210a has a curved shape, the second extending portion 32 has a curved shape along the vehicle interior side surface 210a.

The biasing member 50 according to the present embodiment is configured to press the exterior member 30 toward the slide body 210 both when the slide body 210 is at the fully closed position and when the slide body 210 is at the fully opened position. In other words, the biasing member 50 has rigidity capable of pressing the exterior member 30 against and in contact with the slide body 210 at all times. Therefore, the routing structure 1 according to the present embodiment can stabilize the shape of the exterior member 30. The biasing member 50 can keep the exterior member 30 in contact with the slide body 210 against an external force such as a vibration generated, for example, during traveling.

As will be described below, in the routing structure 1 according to the present embodiment, the plurality of electric wires W have a stranded wire portion Wt extending inside the exterior member 30. FIG. 5 illustrates the biasing member 50 and the plurality of electric wires W before being inserted into the exterior member 30. The plurality of electric wires W have a stranded wire portion Wt. In the stranded wire portion Wt, the plurality of electric wires W are twisted together. In the routing structure 1 according to the present embodiment, two electric wires W are routed between the first fixing part 10 and the second fixing part 20. Therefore, the exemplified stranded wire portion Wt is formed by twisting the two electric wires W together. The plurality of electric wires W have a stranded wire portion Wt, for example, extending from the first fixing part 10 to the second fixing part 20.

The two electric wires W according to the present embodiment are power lines that supply power to devices arranged on the slide body 210. In this case, the two electric wires W are connected to a power source of the vehicle 100 on the side of the vehicle body 110. The two electric wires W may be connected to a power source via an electrical junction box or the like.

The plurality of electric wires W are arranged on the biasing member 50 in such a manner as to extend the stranded wire portion Wt along the biasing member 50. The biasing member 50 and the plurality of electric wires W are inserted into the exterior member 30. As a result, the stranded wire portion Wt extends inside the exterior member 30. The end portions of the exterior member 30 and the biasing member 50 are held by the two fixing parts 10 and 20. The two fixing parts 10 and 20 hold the exterior member 30 so as to form a curved portion between the first end portion 30a and the second end portion 30b of the exterior member 30.

The stranded wire portion Wt according to the present embodiment can be deformed between a first shape illustrated in FIG. 5 and a second shape illustrated in FIG. 6. The stranded wire portion Wt of the first shape illustrated in FIG. 5 has a pitch P1. The pitch P1 is a length in the extending direction Ex of the stranded wire portion Wt, and is a length by which one electric wire W goes around the other electric wire W once. In other words, the pitch P1 is a length corresponding to twice the distance between intersection portions Wx when viewed from a direction orthogonal to the extending direction Ex of the stranded wire portion Wt.

The exemplified stranded wire portion Wt is configured to have the first shape when no external force in the extending direction Ex acts on the stranded wire portion Wt. The stranded wire portion Wt of the first shape has an appropriate gap Gp between the two electric wires W. The gap Gp is determined such that the stranded wire portion Wt can be stretched when a tensile force acts on the stranded wire portion Wt.

As illustrated in FIG. 6, the stranded wire portion Wt of the second shape has a pitch P2. The pitch P2 in the second shape is longer than the pitch P1 in the first shape. That is, the stranded wire portion Wt of the second shape is stretched in the extending direction Ex with respect to the stranded wire portion Wt of the first shape. When a tensile force F3 acts on the stranded wire portion Wt, the stranded wire portion Wt shifts from the first shape to the second shape.

As illustrated in FIG. 3, in the routing structure 1 according to the present embodiment, the electric wires W are disposed outside the biasing member 50 inside the exterior member 30. In this case, when the exterior member 30 and the biasing member 50 are bent in a U shape, the tensile force F3 acts on the electric wires W. That is, the tensile force F3 acts on the stranded wire portion Wt inside the curved portion of the exterior member 30. In the stranded wire portion Wt, the portion on which the tensile force F3 acts is stretched by the tensile force F3, and has the second shape.

The tensile force F3 does not act or the tensile force F3 is small inside the first extending portion 31 and the second extending portion 32 of the exterior member 30. Therefore, the stranded wire portion Wt has the first shape inside the first extending portion 31 and the second extending portion 32. When the position of the curved portion in the exterior member 30 shifts as the slide body 210 moves, the position of the stranded wire portion Wt of the second shape also shifts. In this manner, the stranded wire portion Wt can be stretched or contracted depending on whether the tensile force F3 acts and the magnitude of the tensile force F3. The stranded wire portion Wt can absorb a force generated in the extending direction Ex according to the deformation of the exterior member 30 to reduce the external force acting on each of the electric wires W. Therefore, the routing structure 1 according to the present embodiment can reduce stress generated on the electric wire W and suppress a decrease in durability of the electric wire W.

In the stranded wire portion Wt, the plurality of electric wires W are integrated by crossing each other in a spiral shape. Therefore, the electric wires W hardly enter a gap between the biasing member 50 and the exterior member 30 as compared with the electric wires W independently routed inside the exterior member 30. Therefore, the routing structure 1 according to the present embodiment can suppress a decrease in durability of the electric wire W caused by damage to the electric wire W.

In the plurality of electric wires W, a portion protruding from the exterior member 30 may be routed in a non-twisted state. FIG. 7 illustrates electric wires W having portions that are not twisted together. In FIG. 7, the plurality of electric wires W have a stranded wire portion Wt, a first protruding portion W1, and a second protruding portion W2. In the first protruding portion W1 and the second protruding portion W2, the plurality of electric wires W are not twisted together. That is, in the first protruding portion W1 and the second protruding portion W2, the electric wires W are independent from each other.

The stranded wire portion Wt is disposed along the biasing member 50. The stranded wire portion Wt in FIG. 7 extends from a first end portion 50a to a second end portion 50b of the biasing member 50. The first end portion 50a of the biasing member 50 is an end portion corresponding to the first end portion 30a of the exterior member 30. The second end portion 50b of the biasing member 50 is an end portion corresponding to the second end portion 30b of the exterior member 30.

The stranded wire portion Wt is fixed to the biasing member 50, for example, by a fixing member 40. The fixing member 40 is disposed, for example, at both end portions of the biasing member 50 and the stranded wire portion Wt. The fixing member 40 is, for example, an adhesive tape or a binding band.

The first protruding portion W1 and the second protruding portion W2 are portions of the electric wires W closer to the tail ends than the stranded wire portion Wt. In other words, portions of the electric wires W between the first protruding portion W1 and the second protruding portion W2 are twisted together, so that the stranded wire portion Wt is formed. The plurality of electric wires W are arranged such that the first protruding portion W1 protrudes from the first end portion 50a of the biasing member 50, and the second protruding portion W2 protrudes from the second end portion 50b of the biasing member 50.

When the biasing member 50 and the electric wires W are inserted through the exterior member 30, the first protruding portion W1 protrudes from the first end portion 30a of the exterior member 30. Also, the second protruding portion W2 protrudes from the second end portion 30b of the exterior member 30. The first protruding portion W1 is connected to the power source of the vehicle 100. The second protruding portion W2 is connected to the device on the slide body 210.

In the plurality of electric wires W, the first protruding portion W1 is routed in a non-twisted state. FIG. 8 illustrates the electric wires W connected to a device 130 on the power source side of the vehicle 100. As illustrated in FIG. 8, the first protruding portion W1 is drawn out from the first fixing part 10 to the outside. In the first protruding portion W1, a portion protruding from the first fixing part 10 is routed in a non-twisted state. The plurality of electric wires W in the first protruding portion W1 may be bundled together by a tape or the like. A leading end of the first protruding portion W1 is connected to the device 130 on the power source side. The device 130 on the power source side is, for example, an electrical junction box.

In the plurality of electric wires W, the second protruding portion W2 is routed in a non-twisted state. FIG. 9 illustrates the electric wires W connected to a device 230 disposed on the slide body 210. As illustrated in FIG. 9, the second protruding portion W2 is drawn out from the second fixing part 20 to the outside. In the second protruding portion W2, a portion protruding from the second fixing part 20 is routed in a non-twisted state. The plurality of electric wires W in the second protruding portion W2 may be bundled together by a tape or the like. A leading end of the second protruding portion W2 is connected to the device 230.

The stranded wire portion Wt may be configured to be contractible by receiving a compressive force in the extending direction Ex. FIG. 10 illustrates the stranded wire portion Wt of a third shape. The stranded wire portion Wt in FIG. 10 is configured to have the third shape when no external force in the extending direction Ex acts on the stranded wire portion Wt. The stranded wire portion Wt of the third shape has a pitch P3. The pitch P3 is, for example, longer than the pitch P1 of the stranded wire portion Wt of the first shape. The pitch P3 may be equal in length to the pitch P2 of the stranded wire portion Wt of the second shape. As illustrated in FIG. 11, the stranded wire portion Wt of FIG. 10 is disposed inside the biasing member 50.

In a case where the stranded wire portion Wt is disposed inside the biasing member 50, a compressive force F4 acts on the electric wires W when the exterior member 30 and the biasing member 50 are bent in a U shape. The stranded wire portion Wt is compressed by the compressive force F4, and deformed into a fourth shape illustrated in FIG. 12. The stranded wire portion Wt of the fourth shape has a pitch P4. The pitch P4 in the fourth shape is shorter than the pitch P3 in the third shape. By deforming the stranded wire portion Wt to reduce the pitch, stress generated in the electric wire W is reduced, and a decrease in durability of the electric wire W is suppressed.

Note that the routing structure 1 may include no biasing member 50. In this case, the exterior member 30 is pressed toward the slide body 210 by a repulsive force of the exterior member 30 and the plurality of electric wires W. In a case where the routing structure 1 includes no biasing member 50, the plurality of electric wires W may have a stranded wire portion Wt of a fifth shape. The stranded wire portion Wt of the fifth shape can be stretched so as to increase the pitch when the tensile force F3 acts, and can be contracted so as to decrease the pitch when the compressive force F4 acts.

As described above, the routing structure 1 according to the present embodiment includes a first fixing part 10, a second fixing part 20, an exterior member 30, and a plurality of electric wires W inserted through the exterior member 3. The first fixing part 10 is fixed to a vehicle body 110 of a vehicle 100. The second fixing part 20 is fixed to a slide body 210. The slide body 210 moves along a vehicle front-rear direction X with respect to an opening 120a provided in a roof 120 of the vehicle body 110. The exterior member 30 has a first end portion 30a held by the first fixing part 10 and a second end portion 30b held by the second fixing part 20.

The first fixing part 10 and the second fixing part 20 hold the exterior member 30 to form a curved portion in which the exterior member 30 is curved in the vehicle front-rear direction X between the first end portion 30a and the second end portion 30b. The plurality of electric wires W have a stranded wire portion Wt extending inside the exterior member 30. In the stranded wire portion Wt, the plurality of electric wires W are twisted together. The routing structure 1 according to the present embodiment is capable of stretching or contracting the stranded wire portion Wt to increase or decrease the pitch when the curved portion is formed in the exterior member 30, thereby following the deformation of the exterior member 30. Therefore, the routing structure 1 according to the present embodiment can suppress a decrease in durability of the electric wire W due against bending.

The stranded wire portion Wt may have a gap Gp between the plurality of electric wires W so that the stranded wire portion Wt can be stretched by a tensile force F3. The stranded wire portion Wt with the gap Gp provided between the electric wires W in advance can absorb the tensile force F3 by stretching.

In the plurality of electric wires W, a portion protruding from the exterior member 30 may be routed in a non-twisted state. For example, a first protruding portion W1 protruding from the first end portion 30a of the exterior member 30 may be routed in a non-twisted state. For example, a second protruding portion W2 protruding from the second end portion 30b of the exterior member 30 may be routed in a non-twisted state. Such a configuration can both suppressing a decrease in durability of the electric wire W against bending and reducing an overall length of the electric wire W.

The routing structure 1 may further include a biasing member 50 inserted through the exterior member 30, and a fixing member 40 that fixes the stranded wire portion Wt to the biasing member 50. The fixing member 40 can control the position of the stranded wire portion Wt to a target position and can control the pitch of the stranded wire portion Wt to a target size.

Note that the exterior member 30 is not limited to a so-called corrugated tube. The exterior member 30 may be a braided tube or another member used as an exterior member.

In a case where the routing structure 1 includes a biasing member 50, the shape of the biasing member 50 is not limited to a plate shape. The biasing member 50 may have, for example, a shape like a rod such as a round rod. Both ends of the stranded wire portion Wt may be fixed to the first fixing part 10 and the second fixing part 20, instead of being fixed to the biasing member 50.

The pitch of the stranded wire portion Wt may vary depending on the position of the stranded wire portion Wt in the extending direction Ex. For example, the stranded wire portion Wt may be allowed to stretch and contract more in a portion where a curved portion with a small radius R is formed of the exterior member 30 than in a portion where a curved portion with a large radius R is formed of the exterior member 30. In the arrangement of the stranded wire portion Wt illustrated in FIG. 3, the tensile force F3 acts on the stranded wire portion Wt as the exterior member 30 is curved. In this case, by reducing the pitch of the stranded wire portion Wt of the first shape, it is possible to increase the allowable stretching amount when the tensile force F3 acts.

In the arrangement of the stranded wire portion Wt illustrated in FIG. 11, the compressive force F4 acts on the stranded wire portion Wt as the exterior member 30 is curved. In this case, by increasing the pitch of the stranded wire portion Wt of the third shape, it is possible to increase the allowable contracting amount when the compressive force F4 acts.

The embodiments disclosed above can be carried out in an appropriate combination.

In the routing structure according to the present embodiment, the plurality of electric wires have a stranded wire portion extending inside the exterior member. The routing structure according to the present invention is capable of stretching or contracting the stranded wire portion to increase or decrease the pitch, thereby following the deformation of the exterior member. Therefore, the routing structure according to the present invention is advantageous in that a decrease in durability of the electric wire against bending can be suppressed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a first fixing part fixed to a vehicle body of a vehicle;
a second fixing part fixed to a slide body that moves along a vehicle front-rear direction with respect to an opening provided in a roof of the vehicle body;
an exterior member having a first end portion held by the first fixing part and a second end portion held by the second fixing part; and
a plurality of electric wires inserted through the exterior member, wherein
the first fixing part and the second fixing part hold the exterior member so as to form a curved portion in which the exterior member is curved in the vehicle front-rear direction between the first end portion and the second end portion,
the plurality of electric wires have a stranded wire portion extending inside the exterior member, and
the plurality of electric wires are twisted together in the stranded wire portion.

2. The routing structure according to claim 1, wherein
the stranded wire portion has a gap between the plurality of electric wires so that the stranded wire portion is stretched by a tensile force.

3. The routing structure according to claim 1, wherein
in the plurality of electric wires, a portion protruding from the exterior member is routed in a non-twisted state.

4. The routing structure according to claim 3, further comprising:
a biasing member inserted through the exterior member; and
a fixing member that fixes the stranded wire portion to the biasing member.
